(19) United States
(12) Patent Application Publication
(10) Pub. No.: US 2018/0096629 A1
(43) Pub. Date: Apr. 5, 2018

(54) VIRTUAL DRIVING SCHOOL

(71) Applicant: GM GLOBAL TECHNOLOGY OPERATIONS LLC, Detroit, MI (US)

(72) Inventors: BRIAN D. PAUL, FARMINGTON HILLS, MI (US); ANDREW WASSEF, ROCHESTER, MI (US); WALTER M. LAZAR, II, HOWELL, MI (US)

(73) Assignee: GM GLOBAL TECHNOLOGY OPERATIONS LLC, Detroit, MI (US)

(21) Appl. No.: 15/285,334

(22) Filed: Oct. 4, 2016

(51) Int. Cl. G09B 19/16; G09B 5/06; G09B 19/14

(52) U.S. Cl. CPC G09B 19/167; G09B 19/14; G09B 5/06

(57) ABSTRACT

Methods and systems for providing instruction for new drivers of a vehicle are provided. In accordance with one embodiment, a system includes one or more sensors and a processor. The one or more sensors are configured to monitor operation of a vehicle and environment surrounding the vehicle. The processor is coupled to the one or more sensors, and is configured to at least facilitate identifying a condition pertaining to the operation of the vehicle and the surrounding environment; and providing a notification, for a driver of the vehicle, with instructions pertaining to the condition.

### TECHNICAL FIELD

The present disclosure generally relates to vehicles, and more particularly relates to methods and systems for providing instruction and alerts for new drivers of vehicles.

### BACKGROUND

Today various techniques are utilized for teaching new drivers. While such techniques are often helpful, it may be desirable to provide improved techniques for teaching new drivers.

Accordingly, it is desirable to provide improved techniques for teaching new drivers. It is also desirable to provide methods, systems, and vehicles utilizing such techniques. Furthermore, other desirable features and characteristics of the present invention will be apparent from the subsequent detailed description and the appended claims, taken in conjunction with the accompanying drawings and the foregoing technical field and background.

### SUMMARY

In accordance with an exemplary embodiment, a method is provided. The method comprises monitoring operation of a vehicle and environment surrounding the vehicle; identifying a condition pertaining to the operation of the vehicle and the surrounding environment; and providing a notification, for a driver of the vehicle, with instructions pertaining to the condition.

In accordance with another exemplary embodiment, a system is provided. The system comprises one or more sensors and a processor. The one or more sensors are configured to monitor operation of a vehicle and environment surrounding the vehicle. The processor is coupled to the one or more sensors, and is configured to at least facilitate identifying a condition pertaining to the operation of the vehicle and the surrounding environment; and providing a notification, for a driver of the vehicle, with instructions pertaining to the condition.

In accordance with a further exemplary embodiment, a system is provided. The system comprises one or more sensors and a processor. The one or more sensors are configured to monitor operation of a vehicle and environment surrounding the vehicle. The processor is coupled to the one or more sensors. The processor is configured to at least facilitate identifying an adverse action of a driver of the vehicle based on the monitoring; and adjusting a driving score for the driver based on the adverse action, generating an adjusted score.

### DESCRIPTION OF THE DRAWINGS

The present disclosure will hereinafter be described in conjunction with the following drawing figures, wherein like numerals denote like elements, and wherein:

FIG. 1 is a functional block diagram of a vehicle that includes a control system for providing instructions for new drivers of the vehicle, in accordance with an exemplary embodiment; and

FIG. 2 is a flowchart of a process for providing instruction for new drivers of a vehicle, and that and that can be used in connection with the vehicle and the control system of FIG. 1, in accordance with an exemplary embodiment.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

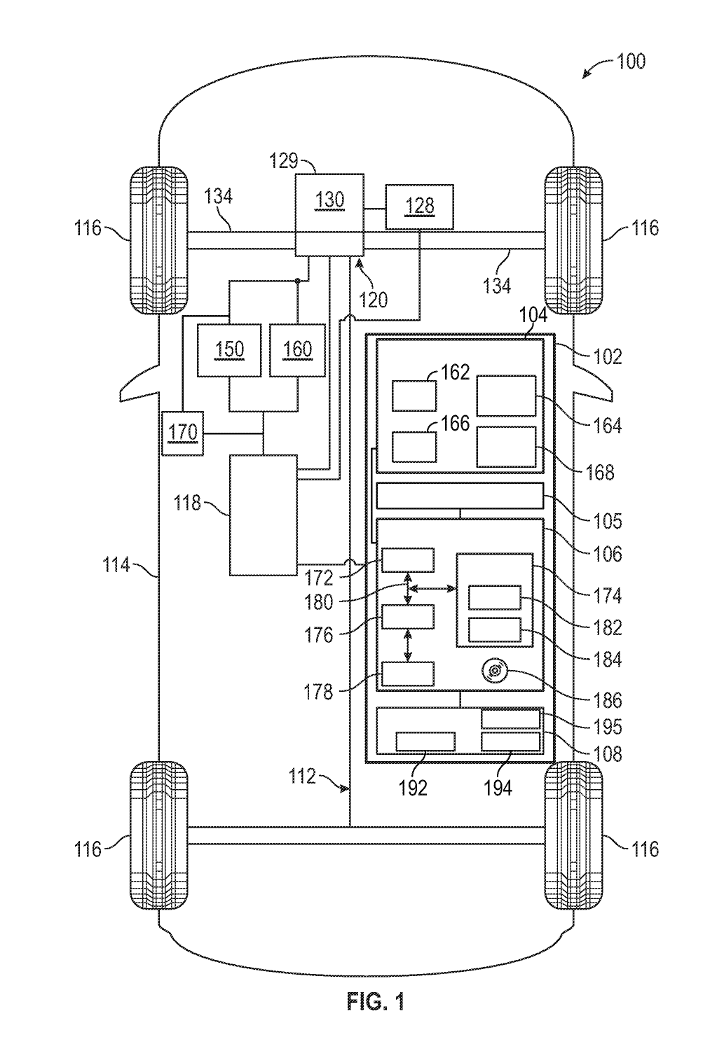

FIG. 1 illustrates a vehicle 100, or automobile, according to an exemplary embodiment. The vehicle 100 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD). In addition, in certain embodiments, the vehicle 100 may comprise any one of a number of other types of vehicles.

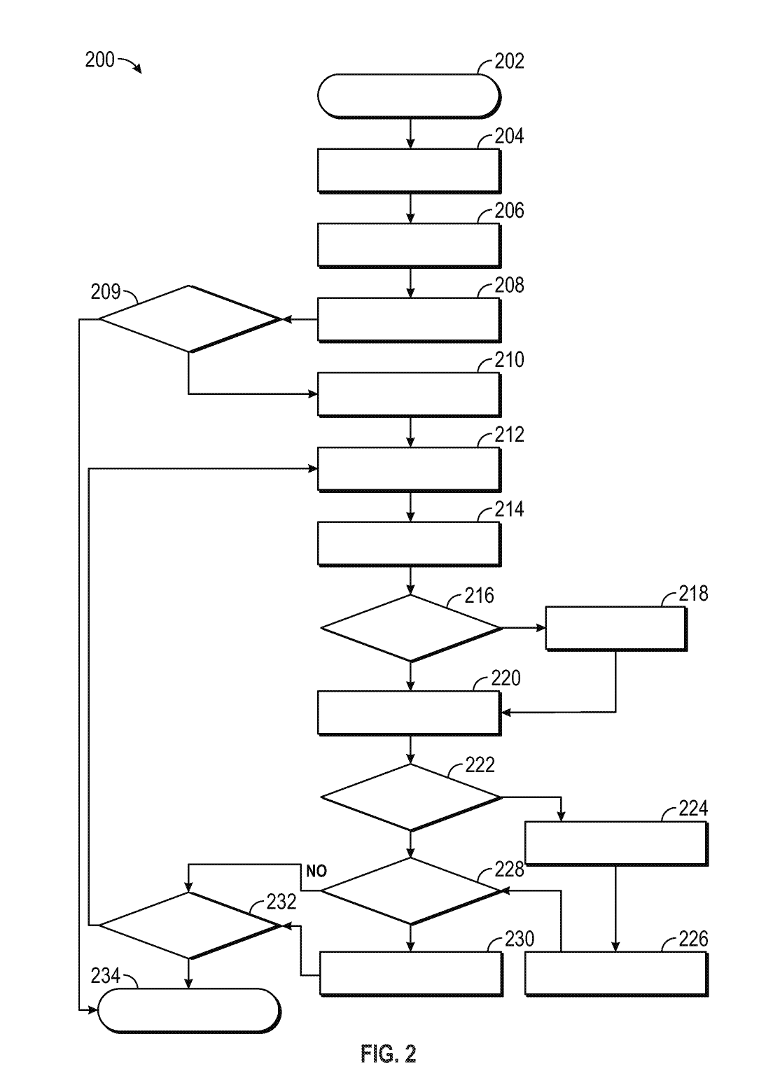

As described in greater detail further below, the vehicle 100 includes a control system 102 for providing instruction for young or new drivers of the vehicle 100, such as for teenagers, other new drivers, and/or other drivers for which instruction or monitoring is desired (collectively hereafter referred to as “new drivers”). Specifically, in certain embodiments, the control system 102 provides audio and/or visual instructions for the driver to implement when encountering a condition on a roadway. In addition, in certain embodiments, the control system 102 calculates and provides a driving score for the driver based on the driving of the vehicle 100 by the driver, after accounting for any adverse actions by the driver. In the depicted embodiment, the control system 102 includes a sensor array 104, a transceiver 105, a controller 106, and a display 108. In various embodiments, the control system 102 performs various steps as set forth further below in connection with the process 200 of FIG. 2.

As depicted in FIG. 1, the vehicle 100 includes, in addition to the above-referenced control system 102, a chassis 112, a body 114, four wheels 116, an electronic control system 118, a steering system 150, a braking system 160, and one or more active system systems 170 (e.g. avoidance, active steering, automatic braking, and so on). The body 114 is arranged on the chassis 112 and substantially encloses the other components of the vehicle 100. The body 114 and the chassis 112 may jointly form a frame. The wheels 116 are each rotationally coupled to the chassis 112 near a respective corner of the body 114. In various embodiments the vehicle 100 may differ from that depicted in FIG. 1. For example, in certain embodiments the number of wheels 116 may vary. By way of additional example, in various embodiments the vehicle 100 may not have a steering system, and for example may be steered by differential braking, among various other possible differences.

In the exemplary embodiment illustrated in FIG. 1, the vehicle 100 includes an actuator assembly 120. The actuator assembly 120 includes at least one propulsion system 129 mounted on the chassis 112 that drives the wheels 116. In one the depicted embodiment, the actuator assembly 120 includes an engine and/or motor 130. In one embodiment, the motor/engine 130 comprises an electric motor/generator that is powered by a rechargeable energy storage system (RESS) 128 (e.g., a vehicle battery). In another embodiment, the motor/engine 130 comprises a gasoline combustion engine. In other embodiments, the motor/engine 130 may include one or more other of these and/or other types of engines and/or motors. In certain embodiments, the electronic control system 118 comprises a motor/engine control system that controls the motor/engine 130 and/or one or more other systems of the vehicle 100.

Still referring to FIG. 1, the motor/engine 130 is coupled to at least some of the wheels 116 through one or more drive shafts 134. In some embodiments, the motor/engine 130 is mechanically coupled to the transmission. In other embodiments, the motor/engine 130 may instead be coupled to a generator used to power an electric motor that is mechanically coupled to the transmission. In certain other embodiments (e.g. electrical vehicles), an engine and/or transmission may not be necessary.

The steering system 150 is mounted on the chassis 112, and controls steering of the wheels 116. In the depicted embodiment, the steering system 150 includes a steering wheel and a steering column (not depicted). In certain embodiments, an autonomous vehicle may utilize steering commands that are generated by a computer, with no involvement from the driver.

The braking system 160 is mounted on the chassis 112, and provides braking for the vehicle 100. The braking system 160 receives inputs from the driver via a brake pedal (not depicted), and provides appropriate braking via brake units (also not depicted). The driver also provides inputs via an accelerator pedal (not depicted) as to a desired speed or acceleration of the vehicle, as well as various other inputs for various vehicle devices and/or systems, such as one or more vehicle radios, other entertainment systems, environmental control systems, lighting units, navigation systems, and the like (also not depicted). Similar to the discussion above regarding possible variations for the vehicle 100, in certain embodiments steering, braking, and/or acceleration can be commanded by a computer instead of by a driver.

The active safety systems 170, in various embodiments, are also mounted on the chassis 112. The active safety systems 170 provide one or more automatic safety features for the vehicle such as, by way of example only, avoidance, active steering, automatic braking, air bag deployment, and so on. It will be appreciated that in certain embodiments the active safety systems 170 may comprise, be coupled to, and/or be part of one or more other vehicle systems (e.g., the steering system 150, the braking system 160, or the ECS 118, by way of example) and/or components thereof.

In one embodiment, the control system 102 is mounted on the chassis 112. The control system 102 obtains information regarding the operation and driving of the vehicle 100 and the environment surrounding the vehicle 100, and provides instruction, for example for new drivers. For example, as noted above and also as described in greater detail below, in certain embodiments the control system 102 provides audio and/or visual instructions for the driver to implement when encountering a condition on a roadway, in accordance with the steps of the process 200 of FIG. 2. Also as noted above and described in greater detail below, in certain embodiments the control system 102 calculates and provides a driving score for the driver based on the driving of the vehicle 100 by the driver, after accounting for any adverse actions by the driver, in accordance with the steps of the process 200 of FIG. 2. In the depicted embodiment, the control system 102 includes a sensor array 104, a transceiver 105, a controller 106, and a display 108. In various embodiments, the control system 102 performs various steps as set forth further below in connection with the process 200 of FIG. 2.

The sensor array 104 includes various sensors (also referred to herein as sensor units and/or detection units) that are used for receiving inputs from a driver of the vehicle 100 and for monitoring certain components of the vehicle 100. In the depicted embodiment, the sensor array 104 includes one or more user interface sensors 162, detection sensors 164, identification sensors 166, and location sensors 168.

The user interface sensors 162 obtain inputs from one or more users of the vehicle, for example using one or more user interfaces. In certain embodiments, the parents or guardians of a new (or young) driver of the vehicle 100 may utilize the user interface to set up and calibrate the control system 102 (e.g. by identifying the new or young drivers, and/or by establishing priorities for driver scoring and/or thresholds for reporting scorers, and so on), with such actions being detected by the user interface sensors 162 for calibration of the control system 102 via the controller 106 (specifically, via the processor 172, discussed below).

The detection sensors 164 sense the environment surrounding the vehicle 100, including roadways, road signs, road characteristics, and other vehicles and other objects on the roadways or otherwise near the vehicle 100. In various embodiments, the detection sensors 164 include one or more cameras, radar, sonar, LIDAR, and/or other detection devices.

The identification sensors 166 receive data identifying the driver of the vehicle 100. In one embodiment, the identification sensors sense a keyfob or other device of the driver, and/or biometric data and/or other data for use in identifying the driver of the vehicle 100. In certain embodiments, this information is instead received via the transceiver 105, described below.

The location sensors 168 provide information pertaining to a current location of the vehicle 100. In certain embodiments, the location sensors 168 are part of a satellite-based location system, such as a global positioning system (GPS).

In various embodiments, the sensor array 104 provides the detected information and data to the controller 106 (e.g. the processor 172 thereof) for processing, for example as set forth in greater detail below. Also in various embodiments, the sensor array 104 performs these and other functions in accordance with the steps of the process 200 described further below in connection with FIG. 2.

The transceiver 105 transmits and/or receives various information for the control system 102. In various embodiments, the transceiver 105 transmits various information (such as instructional content and/or driving scores for the driver of the vehicle 100), for example via an in-vehicle display and/or via electronic transmission for the driver and/or the driver's parents or guardians, for example via text messages and/or e-mails sent to mobile phones and/or other electronic devices of the driver and/or the driver's parents or guardians. In certain embodiments, the transceiver 105 also receives inputs from the driver, for example including an identification of the driver (e.g. via the driver's keyfob). In addition, in certain embodiments, the transceiver 105 also receives information from the driver's parents and/or guardians, for example for calibration of the control system 102.

The controller 106 is coupled to the sensor array 104, the transceiver 105, and the display 108. The controller 106 utilizes the various inputs and data provided via the sensor array 104 and/or the transceiver 105, and providers various notifications (including instructional content for various driving conditions and reporting of driving scores based on the driver's operation of the vehicle 100), via instructions provided to the transceiver 105 and/or the display 108. In various embodiments, the controller 106, along with the sensor array 104, the transceiver 105, and the display 108, provide these and other functions in accordance with the steps discussed further below in connection with the schematic drawings of the vehicle 100 in FIG. 1 and the flowchart pertaining to the process 200 in FIG. 2, discussed further below.

As depicted in FIG. 1, the controller 106 comprises a computer system. In certain embodiments, the controller 106 may also include one or more of the sensors of the sensor array 104, one or more other devices and/or systems, and/or components thereof. In addition, it will be appreciated that the controller 106 may otherwise differ from the embodiment depicted in FIG. 1. For example, the controller 106 may be coupled to or may otherwise utilize one or more remote computer systems and/or other control systems, such as the wheels 116, electronic control system 118, RESS 128, propulsion system 129, motor/engine 130, steering system 150, and/or braking system 160 of FIG. 1, and/or one or more other systems of the vehicle 100.

In the depicted embodiment, the computer system of the controller 106 includes a processor 172, a memory 174, an interface 176, a storage device 178, and a bus 180. The processor 172 performs the computation and control functions of the controller 106, and may comprise any type of processor or multiple processors, single integrated circuits such as a microprocessor, or any suitable number of integrated circuit devices and/or circuit boards working in cooperation to accomplish the functions of a processing unit. During operation, the processor 172 executes one or more programs 182 contained within the memory 174 and, as such, controls the general operation of the controller 106 and the computer system of the controller 106, generally in executing the processes described herein, such as the process 200 described further below in connection with FIG. 2.

The memory 174 can be any type of suitable memory. For example, the memory 174 may include various types of dynamic random access memory (DRAM) such as SDRAM, the various types of static RAM (SRAM), and the various types of non-volatile memory (PROM, EPROM, and flash). In certain examples, the memory 174 is located on and/or co-located on the same computer chip as the processor 172. In the depicted embodiment, the memory 174 stores the above-referenced program 182 along with one or more stored values 184.

The bus 180 serves to transmit programs, data, status and other information or signals between the various components of the computer system of the controller 106. The interface 176 allows communication to the computer system of the controller 106, for example from a system driver and/or another computer system, and can be implemented using any suitable method and apparatus. In one embodiment, the interface 176 obtains the various data from the sensors of the sensor array 104. The interface 176 can include one or more network interfaces to communicate with other systems or components. The interface 176 may also include one or more network interfaces to communicate with technicians, and/or one or more storage interfaces to connect to storage apparatuses, such as the storage device 178.

The storage device 178 can be any suitable type of storage apparatus, including direct access storage devices such as hard disk drives, flash systems, floppy disk drives and optical disk drives. In one exemplary embodiment, the storage device 178 comprises a program product from which memory 174 can receive a program 182 that executes one or more embodiments of one or more processes of the present disclosure, such as the steps of the process 200 (and any sub-processes thereof) described further below in connection with FIG. 2. In another exemplary embodiment, the program product may be directly stored in and/or otherwise accessed by the memory 174 and/or a disk (e.g., disk 186), such as that referenced below.

The bus 180 can be any suitable physical or logical means of connecting computer systems and components. This includes, but is not limited to, direct hard-wired connections, fiber optics, infrared and wireless bus technologies. During operation, the program 182 is stored in the memory 174 and executed by the processor 172.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 172) to perform and execute the program. Such a program product may take a variety of forms, and the present disclosure applies equally regardless of the particular type of computer-readable signal bearing media used to carry out the distribution. Examples of signal bearing media include: recordable media such as floppy disks, hard drives, memory cards and optical disks, and transmission media such as digital and analog communication links. It will be appreciated that cloud-based storage and/or other techniques may also be utilized in certain embodiments. It will similarly be appreciated that the computer system of the controller 106 may also otherwise differ from the embodiment depicted in FIG. 1, for example in that the computer system of the controller 106 may be coupled to or may otherwise utilize one or more remote computer systems and/or other control systems.

The display 108 is coupled to the controller 106, and provides notifications for the driver of the vehicle 100 and/or for other users (e.g. the driver's parents). Specifically, the display 108 provides and/or visual instructions for the driver to implement when encountering a condition on a roadway. In addition, in certain embodiments, the display provides a driving score for the driver based on the driving of the vehicle 100 by the driver, after accounting for any adverse actions by the driver. In the depicted embodiment, the display 108 includes an audio component 192 and a visual component 194. The audio component 192 provides audio instructions for the driver to implement when encountering a condition on a roadway (e.g. audio instructions as to a commonly accepted protocol for a four way stop, and/or any number of other conditions that may be encountered on a roadway), and in certain embodiments also provides an audio notification regarding the driving score. The visual component 194 provides a visual notification regarding the driving score, and in certain embodiments also provides visual instructions for the conditions encountered on the roadway. In certain embodiments, the visual component 194 comprises a vehicle heads-up display, and/or a visual screen display, for example within or proximate a dash board or center region of the front of the vehicle 100. In various embodiments, the display 108 provides the information and notifications in accordance with instructions provided by the processor 172. In certain embodiments, the display 108 also includes a haptic component 195, for example that provides haptic warnings or notifications (e.g., a vibrating seat, or a connection to or short range wireless communication with, an electronic watch or other wearable or other device of the driver) when encountering a condition on a roadway (e.g. that provides a warning when the vehicle 100 is closely approaching another vehicle or object, among other possible conditions). In certain embodiments, the processor 172 may provide instructions for some of this information (e.g. the driver's score) to be provided instead via the transceiver 105 (e.g. via e-mail or text message to the driver's parents, and so on). Also in various embodiments, the display 108 performs these and other functions in accordance with the steps of the process 200 described further below in connection with FIG. 2.

While the components of the control system 102 (including the sensor array 104, transceiver 105, the controller 106, and the display 108) are depicted as being part of the same system, it will be appreciated that in certain embodiments these features may comprise two or more systems. In addition, in various embodiments the control system 102 may comprise all or part of, and/or may be coupled to, various other vehicle devices and systems, such as, among others, the actuator assembly 120 (e.g. the propulsion system 129 and/or the motor/engine 130), the RESS 128, the electronic control system 118, the steering system 150, the braking system 160, and/or one or more other systems of the vehicle 100.

FIG. 2 is a flowchart of a process 200 for providing instruction pertaining to a driver of a vehicle, in accordance with an exemplary embodiment. The process 200 can be implemented in connection with the vehicle 100, including the control system 102 and other systems, sub-systems, and components thereof of FIG. 1, in accordance with an exemplary embodiment.

As depicted in FIG. 2, the process 200 is initiated at step 202. In one embodiment, the process 200 begins at step 202 during set-up of the control system 102 of FIG. 1 prior to a vehicle drive cycle or ignition cycle (e.g. during manufacturing, or during set-up by a parent of a new driver before the new driver begins driving the vehicle). Also in certain embodiments, after the initial set-up, the process 200 may subsequently start instead at step 206, during a current vehicle drive, discussed below.

The control system is calibrated (step 204). In one embodiment, one or both parents (or other guardians) of a new driver (for example, as defined above in connection with FIG. 1) calibrate the control system 102 of FIG. 1 during step 204. In certain embodiments, the new driver is identified with an associated keyfob or other identifying device (e.g. in certain embodiments, one or more biometric features of the new driver) for future identification of the new driver. Also in certain embodiments, the parents or guardians may calibrate the control system with preferences, including a desired weighting for different parameters for inclusion in the determination of the driving score for the new driver (e.g., if the parents prefer relatively higher weighting be placed on speed versus braking, and/or various other parameters), as well as one or more preferred methods of communication the driver score and/or other information (e.g. by including the parents' e-mail or cell phone information to receive driver score updates, and/or by including a desired frequency for receiving score updates, and so on). In certain embodiments, the calibration is initiated inside the vehicle using a user interface and associated user interface sensors 162 of FIG. 1. In certain other embodiments, the calibration is initiated remotely, for example online and/or via communication with the processor 172 of FIG. 1 via the transceiver 105 of FIG. 1. In various embodiments, the calibration is then completed via the processor 172 of FIG. 1 by storing the calibrated values in the memory 174 of FIG. 1 as stored values 184 thereof. Also in certain embodiments, similar to the discussion above, the calibration is performed prior to a vehicle drive or ignition cycle for the new driver. Once the calibration is performed, subsequent iterations of the process 200 may begin directly at step 206, for example unless an updated calibration is desired.

A vehicle start is identified (step 206). In various embodiments, the vehicle start comprises a beginning of a vehicle drive or ignition cycle for the vehicle. Also in various embodiments, the vehicle start is identified by one or more driver actions representing a desire to begin the current vehicle drive, for example by turning an ignition key, pressing a start button, opening or unlocking a vehicle door, and so on. In various embodiments, the vehicle start is identified via information obtained from one or more user interface sensors 162 and/or identification sensors 166 of the sensor array 104 of FIG. 1. In one embodiment, the vehicle start is detected via one or more identification sensors 166 that detect a keyfob used by the driver.

A driver is identified (step 208). In various embodiments, an identification is made, using data from one or more identification sensors 166 of the sensor array 104 of FIG. 1, as to a particular driver that is requesting or initiating the current vehicle drive (e.g. by turning the ignition key, pressing a start button, engaging a keyfob, sitting in the driver's seat, or the like). Also in one embodiment, the processor 172 identifies the particular driver by comparing a detected keyfob (as detected via one or more identification sensors 166 of FIG. 1) with a known keyfob for the driver stored as a stored value 184 in the memory 174 of FIG. 1 (e.g. during calibration of the control system 102 in step 204).

A determination is made as to whether the identified driver is a new driver, for which monitoring or instructions is desired (step 209). In various embodiments, the processor 172 of FIG. 1 determines whether the driver identified in step 208 is a new driver referred to in the calibration of step 204.

If it is determined that the identified driver is not a new driver (e.g. for which instruction or monitoring is not desired), then the process terminates at step 234. Conversely, if it is determined that the identified driver is a new driver (e.g., for which instruction or monitoring is desired), then the process proceeds instead to step 210, described directly below.

During step 210, a current score is retrieved for the driver. In various embodiments, the processor 172 of FIG. 1 retrieves a current, or most recent, score for the identified driver from the stored values 184 of the memory 174 of FIG. 1. In certain embodiments, if this is the first time that the process is utilized for a particular driver, then a default score may be retrieved in step 210 (e.g., a default score of 100 may be used in certain embodiments, although this may vary in other embodiments). Also in certain embodiments, the driving score may be re-set to the default value every so often (e.g., if the driving score is set to restart every drive cycle, every week, every month, or the like, then the driving score may be re-set as part of step 210 at the beginning of each drive cycle, week, or month, respectively, and so on, in certain embodiments). The driving score will then be updated based on the driver's operation of the vehicle during the current vehicle drive, for example as described further below.

The vehicle is monitored (step 212). In various embodiments, various parameters are monitored with respect to the vehicle and operation thereof, for example via data provided via the sensor array 104 of FIG. 1 and/or various communications with different vehicle components and systems (e.g., the wheels 116, the ECS 118, the RESS 128, the steering system 150, the braking system 160, the active safety systems 170, and so on). The parameters derived from the monitoring may include, among various others, vehicle speed and speed histories, vehicle steering and steering histories, vehicle braking and braking histories, engine operation, and active safety system initiation (e.g. initiation of automatic braking, automatic avoidance maneuvers, deployment of air bags, and so on).

An environment surrounding the vehicle is also monitored (step 214). In various embodiments, various parameters are monitored with respect to the vehicle and operation thereof, for example road conditions, road and traffic signs and indicators, weather conditions, the presence of other vehicles and/or objects detected in proximity to the vehicle 100 and location and movement thereof, location and movement of the vehicle, and so on. In various embodiment, the processor 172 of FIG. 1 monitors such parameters via data provided via the sensor array 104 of FIG. 1, for example including the location sensors 168 (e.g. for a GPS unit for detection a geographic location of the vehicle 100) and the detection sensors 164 (e.g. including cameras, radar, LIDAR, sonar, and so on, for detection other vehicles and objects in proximity to the vehicle 100).

A determination is made as to whether a condition is present in proximity to the vehicle that may require instruction for the driver (step 216). In various embodiments, the determination of step 216 is made by the processor 172 of FIG. 1 using the various data and parameters of steps 212 and 214. In various embodiments, the conditions of step 216 may include by way of example the following: approaching a four way stop, tailgating another vehicle, approaching a railroad track, following a school bus, approaching a stop sign, turning onto a divided highway, changing lanes, turning in front of another vehicle, approaching a roundabout or rotary, driving in a school zone, driving in a construction zone, and travelling at a relatively high speed, among various other possible conditions.

If it is determined in step 216 that a condition is present that requires instruction, then such instructions (e.g. notifications) are provided for the driver (step 218). Otherwise, the process proceeds direction to step 220, described further below. In various embodiments, the instructions of step 218 are provided via the display 108 of FIG. 1 in accordance with instructions provided by the processor 172 of FIG. 1 (e.g. via the audio component 192, the visual component 194, and/or the haptic component 195).

In various embodiments, the instructions comprise audio, visual, and/or haptic instructions for a commonly accepted, or best practice, for what actions the driver is expected to take in such a situation corresponding to the detected condition. For example, if the driver is approaching a four-way stop (e.g. as detected via a camera of the vehicle), the instruction may state that “you are approaching a four way stop, and that vehicle on the right has the right of way.” Similarly, other appropriate notifications may be provided in accordance with other conditions, such as “you are making a right turn into a divided highway, so only turn into the right most lane”, “you are following the vehicle ahead too closely”, “you did not stop at the stop sign long enough”, “you are entering a school zone, so reduce your speed and be on the lookout for children”, “you are driving too fast”, “you are exceeding the speed limit”, “you did not provide enough room before turning in front of another vehicle”, “you cannot stop this close to a railroad track”, “there is a school bus dropping off children, so you must leave extra room”, “you need to signal when changing lanes”, and so on. As alluded to above, in certain cases the notification may comprise an instruction for what to do next, while in other cases the notification may comprise an instruction pertaining to an action that the driver has just taken (so that the driver can learn from this and adjust his or her subsequent driving habits according). The process also proceeds to step 220, described directly below.

During step 220, monitoring is provided with respect to the operation of the vehicle by the driver. In various embodiments, during step 220, the processor 172 of FIG. 1 analyzes various data collected in steps 212-216 with respect to possible adverse actions that may have been taken by the driver.

The processor then determines whether such an adverse action has taken place (step 222). As referred to herein, “adverse actions” may include driver actions that are adverse, not preferred, and/or that may lead to a less safe or less than ideal situation. By way of example, such adverse actions may include, among various other possible actions, tailgating (e.g. following another vehicle too closely), usage of the accelerator and/or brake pedal in a manner that may be inconsistent with cautious driving (e.g. moving between the accelerator pedal and/or brake pedal too frequently, and/or engaging the accelerator pedal, brake pedal, and/or steering wheel too hard, e.g. possibly representing speeding, racing, or a need for last moment avoidance), exceeding the speed limit, driving too fast in a school zone, stopping too close to a railroad track, stopping too close to a school bus dropping off children, failing to signal when changing lanes, leaving insufficient space when turning in front of another vehicle, actions resulting in initiation of an active safety system such as automatic braking, avoidance, or deployment of air bags, and so on.

If it is determined that an adverse action has been taken by the driver, then the driving score for the driver is adjusted (step 224). Specifically, in one embodiment, the driver's current driver score (e.g. as retrieved in step 210) is adjusted downward based on adverse actions being performed by the driver, and/or as a result of adverse consequences from the driver's actions. In various embodiments, the driving score may be adjusted downward in a magnitude that is based on the severity and/or frequency of the adverse action. For example, in one embodiment, the driving score may be reduced (A) by a relatively larger amount if the vehicle speed exceeds a speed limit by a relatively large amount, for a relatively longer period of time, or on multiple occasions, or (B) by a relatively smaller amount if the vehicle speed exceeds a speed limit by a relatively small amount, for a relatively shorter period of time, on only one occasion, or the like. Also in various embodiments, certain other types of conditions may be provided greater weight than others, for example either via the default settings and/or through calibration in step 204.

The updated score is then saved (step 226). In various embodiments, the updated score (reflecting the adjustments of step 224) is saved by the processor 172 of FIG. 1 into the memory 174 of FIG. 1 as a stored value 184 therein. The process then proceeds to step 228, discussed below. Also, with additional reference to step 222, if no adverse actions are detected, then the process proceeds directly from step 222 to step 228, without any score adjustments.

During step 228, a determination is made as to whether a reporting threshold has been met. In various embodiments, this determination is made by the processor 172 of FIG. 1 with respect to a reporting threshold established during the calibration of step 204. For example, in one embodiment, if a notification is requested every time that a score adjustment is made, then the reporting threshold is met whenever an adjustment occurs in an iteration of step 222. By way of further example, if a notification is requested whenever the driving score has been adjusted by a certain magnitude, then the reporting threshold is met whenever adjustments of iterations of step 224 result in a combined score adjustment that is greater than or equal to the certain magnitude, in one embodiment. By way of additional example, if a notification is requested after completion of each vehicle drive (e.g. each ignition cycle), then the reporting condition is satisfied at the completion the vehicle drive. after completion of each vehicle drive (e.g. each ignition cycle), then the reporting condition is satisfied at the completion the vehicle drive. By way of another example, if a notification is requested after completion of each week (or month), then the reporting condition is satisfied at the completion of each week (or month), and so on. In yet other embodiments, driving score reports may be available “on demand”, such that a reporting threshold may be made when a parent or guardian makes a request to receive the driving score.

If it is determined in step 228 that the reporting threshold has been met, then the current driving score is reported (step 230). Otherwise, the process proceeds instead to step 232, described further below.

During step 230, the current driving score for the driver (e.g. as updated in step 224 and saved in step 226) is reported. In various embodiments, the driving score is reported via instructions provided by the processor 172 of FIG. 1 to the display 108 of FIG. 1 and/or the transceiver 105 of FIG. 1. In certain embodiments, the driving score is transmitted (e.g. by the transceiver 105) to the computer, mobile phone, or other electric devices of the parents or guardians of the driver, for example as established during the calibration. Also in certain embodiments, the driving score may be similar provided to an electronic device of the driver. In certain embodiments, the driving score is displayed (in an audio and/or visual manner) via the display 108 of FIG. 1 within the vehicle 100 (in certain such embodiments a password may be required, for example for viewing only by the parents, guardians, and/or driver, and in other embodiments a password may not be required). The process then proceeds to step 232, described directly below.

In certain embodiments, during step 232, a determination is made whether the current vehicle drive cycle (e.g. the current vehicle ignition cycle) is over. In various embodiments, the processor 172 of FIG. 1 may make this determination, for example using data from one or more sensor as to whether a vehicle, engine, or ignition is being turned off, for example via turning of a key, pressing of a stop button, engagement of a keyfob, or so on. It will be appreciated that, in certain embodiments, this determination may already be made as part of step 228 (e.g. if the reporting threshold is related to the end of the vehicle drive cycle).

If the current drive cycle is determined to be over, then the process returns to step 212, for further monitoring. Conversely, if the current drive cycle is determined to be over, then the process terminates (step 234).

Accordingly, methods, systems, and vehicles are provided for providing instruction for drivers of a vehicle. The disclosed methods, systems, and vehicle provide instructions for new or young drivers with respect to conditions encountered during a vehicle drive. In addition, a driving score for the driver is maintained and updated based on any adverse actions taken by the driver in driving the vehicle.

It will be appreciated that the disclosed methods, systems, and vehicles may vary from those depicted in the Figures and described herein. For example, the vehicle 100, the control system 102, and/or various components thereof may vary from that depicted in FIG. 1 and described in connection therewith. In addition, it will be appreciated that certain steps and/or implementations of the process 200 may vary from those depicted in FIG. 2 and/or described above in connection therewith. It will similarly be appreciated that certain steps of the methods described above may occur simultaneously or in a different order than that depicted in FIG. 2 and/or described above in connection therewith.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the appended claims and the legal equivalents thereof.

What is claimed is:

1. A method comprising:
monitoring operation of a vehicle and environment surrounding the vehicle;
identifying a condition pertaining to the operation of the vehicle and the surrounding environment; and
providing a notification, for a driver of the vehicle, with instructions pertaining to the condition.

2. The method of claim 1, wherein the step of providing the notification comprises:
providing instructions for driving with respect to the identified condition.

3. The method of claim 2, wherein the step of providing the instructions comprises:
providing audio instructions, within the vehicle, for driving with respect to the identified condition.

4. The method of claim 2, wherein the step of providing the instructions comprises:
providing visual instructions, within the vehicle, for driving with respect to the identified condition.

5. The method of claim 2, wherein the step of providing the instructions comprises:
providing a haptic warning, within the vehicle, for driving with respect to the identified condition.

6. The method of claim 1, further comprising:
identifying an adverse action taken by the driver of the vehicle; and
adjusting a driving score for the driver based on the adverse action, generating an adjusted score.

7. The method of claim 6, wherein the step of adjusting the driver score comprises reducing the driver score based on a relative magnitude of associated driving risk associated with the adverse action.

8. The method of claim 6, further comprising:
determining whether a reporting condition has been met; and
reporting the adjusted score if the reporting condition has been met.

9. The method of claim 8, wherein the step of reporting the adjusted score comprises:
transmitting an electronic notification reporting the adjusted score if the reporting condition has been met.

10. A system comprising:
one or more sensors configured to monitor operation of a vehicle and environment surrounding the vehicle; and
a processor coupled to the one or more sensors, the processor configured to at least facilitate:
identifying a condition pertaining to the operation of the vehicle and the surrounding environment; and
providing a notification, for a driver of the vehicle, with instructions pertaining to the condition.

11. The system of claim 10, wherein the processor is configured to at least facilitate providing instructions for driving with respect to the identified condition.

12. The system of claim 11, wherein the processor is configured to at least facilitate providing audio instructions, within the vehicle, for driving with respect to the identified condition.

13. The system of claim 11, wherein the processor is configured to at least facilitate providing visual instructions, within the vehicle, for driving with respect to the identified condition.

14. The system of claim 11, wherein the processor is configured to at least facilitate providing a haptic warning, within the vehicle, for driving with respect to the identified condition.

15. The system of claim 10, wherein the processor is configured to at least facilitate:
identifying an adverse action taken by the driver of the vehicle; and
adjusting a driving score for the driver based on the adverse action, generating an adjusted score.

16. The system of claim 15, wherein the processor is configured to at least facilitate reducing the driver score based on a relative magnitude of associated driving risk associated with the adverse action.

17. The system of claim 15, wherein the processor is configured to at least facilitate:
determining whether a reporting condition has been met; and
reporting the adjusted score if the reporting condition has been met.

18. The system of claim 17, further comprising:
a transmitter coupled to the processor, the transmitter configured to transmit, in accordance with instructions provided by the processor, an electronic notification reporting the adjusted score if the reporting condition has been met.

19. A system comprising:
one or more sensors configured to monitor operation of a vehicle and environment surrounding the vehicle; and
a processor coupled to the one or more sensors, the processor configured to at least facilitate:
identifying an adverse action of a driver of the vehicle based on the monitoring; and
adjusting a driving score for the driver based on the adverse action, generating an adjusted score.

20. The system of claim 19, wherein the processor is configured to at least facilitate reducing the driver score based on a relative magnitude of associated driving risk associated with the adverse action.
